(19) United States
(12) Patent Application Publication
(10) Pub. No.: US 2011/0081175 A1
(43) Pub. Date: Apr. 7, 2011

(54) IMAGE FORMING APPARATUS AND FUSER UNIT

(75) Inventors: Toshihiro Sone, Kanagawa-ken (JP); Satoshi Kinouchi, Tokyo-to (JP); Ryota Saeki, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/874,509

(22) Filed: Sep. 2, 2010

Related U.S. Application Data
(60) Provisional application No. 61/248,600, filed on Oct. 5, 2009.

(51) Int. Cl. G03G 15/20

(52) U.S. Cl. 399/330; 399/333

(57) ABSTRACT

According to one embodiment, a fuser including, a first endless member including a gel-like silicone material and configured to apply heat to an object, a second endless member configured to apply pressure to the first endless member, and a heat source configured to raise temperature of the first endless member to predetermined temperature.

### CROSS-REFERENCE TO RELATED APPLICATIONS

This application is based upon and claims the benefit of priority from: U.S. Provisional Application No. 61/248,600 filed on Oct. 5, 2009, the entire contents of each of which are incorporated herein reference.

### FIELD

Embodiments described herein relate generally to an image forming apparatus and a fuser unit.

### BACKGROUND

A toner (a visualizing agent) moves to a sheet medium on the basis of image information and is integrated with the sheet medium. The sheet medium (integrated with the toner) is a hard copy.

A fuser unit integrates the toner with the sheet medium.

### BRIEF DESCRIPTION OF THE DRAWINGS

A general architecture that implements the various features of the embodiments will now be described with reference to the drawings. The drawings and the associated descriptions are provided to illustrate embodiments and not to limit the scope of the embodiments.

FIG. 1 is an exemplary diagram showing an example of an MFP (Multi-Functional Peripheral) according to an embodiment;

FIG. 2 is an exemplary diagram showing an example of a fuser of the MFP, according to an embodiment;

FIG. 3 is an exemplary diagram showing an example of a fuser of the MFP, according to an embodiment;

FIG. 4A is an exemplary diagram showing an example of a fuser of the MFP, according to an embodiment;

FIG. 4B is an exemplary diagram showing an example of a fuser of the MFP, according to an embodiment;

FIG. 5 is an exemplary diagram showing an example of a fuser of the MFP, according to an embodiment;

FIG. 6 is an exemplary diagram showing an example of a fuser of the MFP, according to an embodiment;

FIG. 7A is an exemplary diagram showing an example of a fuser of the MFP, according to an embodiment;

FIG. 7B is an exemplary diagram showing an example of a fuser of the MFP, according to an embodiment;

FIG. 8 is an exemplary diagram showing an example of a fuser of the MFP, according to an embodiment; and

FIG. 9 is an exemplary diagram showing an example of a fuser of the MFP shown in FIG. 1, according to an embodiment.

### DETAILED DESCRIPTION

In general, according to one embodiment, a fuser comprising: a first endless member including a gel-like silicone material and configured to apply heat to an object; a second endless member configured to apply pressure to the first endless member; and a heat source configured to raise temperature of the first endless member to predetermined temperature.

Embodiments will now be described hereinafter in detail with reference to the accompanying drawings.

An example of an embodiment is explained in detail below with reference to the accompanying drawings.

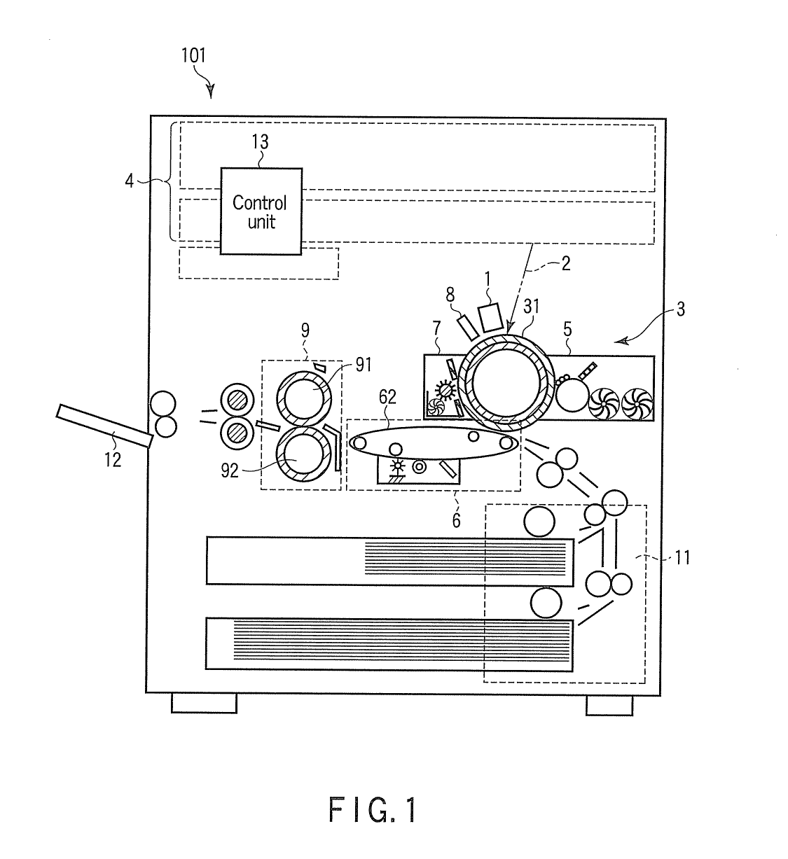

An image forming apparatus (MFP: Multi-Functional Peripheral) 101 shown in FIG. 1 includes at least a charging unit 1, a writing (exposing) unit 2, an image forming (latent image forming, developing, transferring, and cleaning) unit 3, a document reading unit 4, a developing unit 5, a transfer unit (a peeling unit) 6, a cleaning unit 7, a charge removing unit 8, and a fixing unit 9.

The charging unit 1 gives charges having predetermined polarity (in this example, “− (minus)”) to a photoconductive layer on the surface of an image bearing member, for example, a cylindrical drum 31 included in the image forming unit 3 explained below. The image bearing member is not limited to the cylindrical drum and may be an endless belt or a cylindrical drum member located on the inner side of the endless belt.

The writing (exposing) unit 2 irradiates exposure light, for example, a laser beam, light intensity of which changes according to image information as a target of image formation, on the photoconductive layer on the surface of the cylindrical drum (hereinafter referred to as photoconductive drum) 31 charged by the charging unit 1 and changes the potential of the photoconductive layer. A latent image is formed in a section where the potential is changed. The image information is provided by the document reading unit 4 explained below or an external apparatus such as a PC (Personal Computer) or a facsimile. The photoconductive drum 31 has an external diameter of, for example, 100 mm and includes a photoconductive layer 33 on the surface of a metal substrate (hollow aluminum) 32 as indicated by an example shown in FIG. 3. The photoconductive layer includes, for example, an organic photoconductive member (OPC).

The image forming (latent image forming, developing, transferring, and cleaning) unit 3 conveys a toner image obtained by developing (visualizing) the latent image with toner (a visualizing agent) provided by the developing device 5 to the transfer unit 6, the cleaning unit 7, and the charge removing unit 8 according to the rotation of the image forming unit 3. The photoconductive drum 31 rotates, for example, clockwise (in a CW (clockwise) direction) at predetermined speed.

The document reading unit 4 includes a document reading device. The document reading device includes, for example, a CCD sensor with 600 dpi (dots per inch)/7500 pixels (a total number of pixels in a longitudinal direction thereof) and converts image information as a reflected light signal of irradiated light into an electric signal.

The developing unit 5 includes a magnet roller and a developing sleeve locates on the outer circumference of the magnet roller and rotates on the outer circumference. The magnet roller selectively provides toner, which moves on the surface of the developing sleeve according to the rotation of the developing sleeve, to the latent image on the surface of the photoconductive drum 31 while magnetically attracting the toner. A space between the developing sleeve and the photoconductive drum 31 is managed by a guide roller set in contact with the surface of the photoconductive drum 31. The developing sleeve is formed of a nonmagnetic material such as stainless steel or aluminum.

The transfer unit (the peeling unit) 6 moves, with an electric field provided by a transfer roller, the toner image onto a sheet conveyed by a sheet conveying belt 62 (toners forming the toner image subjected to the electric field provided by the transfer roller move to the sheet). A peeling unit separates the toner (the toner image) and the sheet from the surface of the photoconductive drum.

In the cleaning unit 7, include a waste toner and foreign matter storing unit and stores a transfer residual toner (a waste toner), fiber pieces of a sheet, a surface coating agent, or the like scraped off by a removing mechanism such as a brush member (or a brush roller having a cylindrical brush) or a foreign matter conveyed together with the sheet.

The charge removing unit 8 resets the potential of the photoconductive layer on the surface of the image bearing member 31 to an initial state before the charging by the charging unit 1 (removes residual charges on the photoconductive member). The charge removing unit 8 includes an LED array in which LED elements configured to output red light having wavelength longer than, for example, 770 nm are arranged in an axis direction of the drum 31.

The image forming apparatus 101 further includes a paper feeding unit 11 configured to feed a sheet to the transfer unit 6 of the image forming unit 3 and a paper discharge unit 12 configured to receive a sheet on which a toner image is fixed by the fixing unit 9. The image forming apparatus 101 forms a toner image corresponding to image information provided by the document reading unit 4 or an apparatus such as a PC (Personal Computer) or a facsimile.

Specifically, when image formation is instructed from an operation unit or an external apparatus not shown in the figure, process control by the image forming unit 3 and fixing temperature control by the fixing unit 9 are started according to the control by the control unit 13. A copy output or a printout (a print output) is output by, for example, latent image formation, development, transfer, and cleaning in the image forming unit 3, movement of the toner image to the sheet from the paper feeding unit 11 by the transfer and peeling unit 6, and sheet conveyance control according to image information input by the document reading unit 4 or the external apparatus.

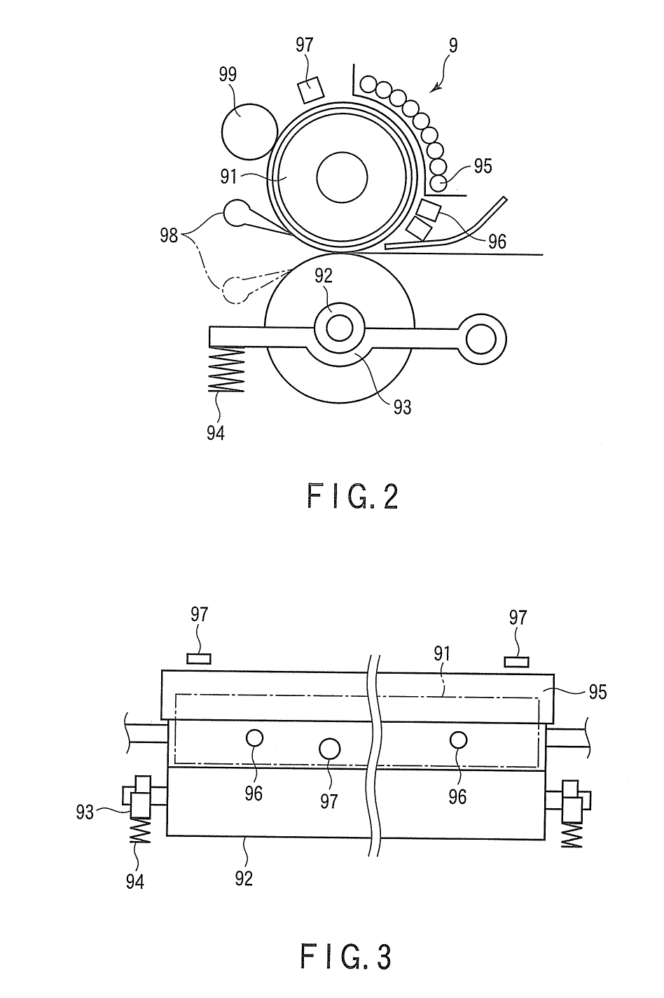

As indicated by an example shown in FIG. 2, the fuser unit 9 includes a first roller 91 (e.g., φ40 mm) and a second roller 92 (e.g., φ40 mm) configured to provide a nip 90 defined by both the rollers 91 and 92 that come into contact with each other. An outer circumferential surface of one of the first roller 91 and the second roller 92 is brought into contact with an outer circumferential surface of the other by a spring 94 configured to apply pressure to a roller supporting member 93 configured to support the first roller 91 or the second roller 92. The roller supporting member 93 is located in a release position for reducing the pressure between the rollers to substantially zero when an image is not output, in particular, in a sleep mode or the like.

A heating device 95 raises the temperature of the outer circumferential surface (surface temperature) of at least one of the first roller 91 and the second roller 92 to predetermined temperature (the heating device 95 heats the roller surface). The surface temperature is, for example, in a predetermined range including 160°. The surface temperature is adjusted to be within the predetermined range by temperature control conforming to a result of detection by a temperature sensor (thermistor) 96. The heating device 95 includes, for example, an induction heater (IH). When the heating device 95 is the IH, an excitation coil may be divided (two or more coils can be used). As an excitation circuit, readily-available various types can be used. As the heating device 95, a type for making use of radiation heat by a halogen lamp or the like can also be used.

The abnormal temperature detecting mechanism (thermostat) 97 detects that the surface temperatures of both the rollers are higher than planned temperature and it is difficult to perform the control conforming to an output of the temperature sensor 96. The abnormal temperature detecting mechanism 97 prevents a temperature rise to unexpected temperature of at least one roller or overheating (burning) of a sheet member, which moves through the nip, due to abnormality of the heating device 95 or the temperature sensor 96. The abnormal temperature detecting mechanism 97 is located in a predetermined position near the temperature sensor 96 or near the outer circumferential surfaces (the circumferences) of both the rollers.

A peeling claw 98 separates (peels off) a sheet member, which does not separate from the outer circumference of the roller 91 or the roller 92 depending on viscosity of a toner, from the roller in a position downstream in a rotating direction of one of the rollers from the nip 90. The peeling claw 98 is located in a predetermined position on the outer circumference of the first roller 91 or the second roller 92. Two or more of the peeling claws 98 may be respectively located on the outer circumference of the first roller 91 and the outer circumference of the second roller 92. The peeling claws 98 may be prepared in a longitudinal direction of each of the rollers. The peeling claw 98 may be omitted.

A cleaner 99 removes a toner remaining on the roller surface in a position downstream in the rotating direction of one of the first roller 91 or the second roller 92 from the nip 90. The cleaner 99 is located in, for example, a predetermined position on the outer circumference of the first roller 91 or the second roller 92. Two or more of the cleaners 99 may be respectively located on the outer circumference of the first roller 91 and the outer circumference of the second roller 92.

A sheet member (recording paper) carrying a toner (a recording agent) passes through the nip 90. The toner is melted and fusion-bonded to the sheet member when the sheet member passes through the nip 90. The nip 90 is, for example, 8 mm, desirably, 14.5 mm, and more desirably 20 mm on the outer circumference surfaces (the circumferences) of both the rollers.

As indicated by an example shown in FIG. 3, the temperature sensor 96 measures the surface temperature of the first roller 91 or the second roller 92 in at least one place in the longitudinal direction of the roller. Desirably, two or more of the temperature sensors 96 are located in at least two or more places (measure the surface temperatures in at least two places in the longitudinal direction of the roller). The abnormal temperature detecting mechanism 97 is located in a predetermined position near the temperature sensor 96 or near the outer circumferential surfaces (the circumferences) of both the rollers. The abnormal temperature detecting mechanism 97 detects that the surface temperature is higher than planned temperature and it is difficult to perform the control conforming to an output of the temperature sensor 96. As indicated by shown in FIG. 3, for example, the abnormal temperature detecting mechanism 97 measures the surface temperature of the first roller 91 or the second roller 92 at least in one place in the longitudinal direction of the roller. Desirably, a plurality of the abnormal temperature detecting mechanisms 97 are located in two or more places, for example, at both ends of the roller and generally in the center in the longitudinal direction of the roller (measure abnormal temperature at least in three places in the longitudinal direction of the roller).

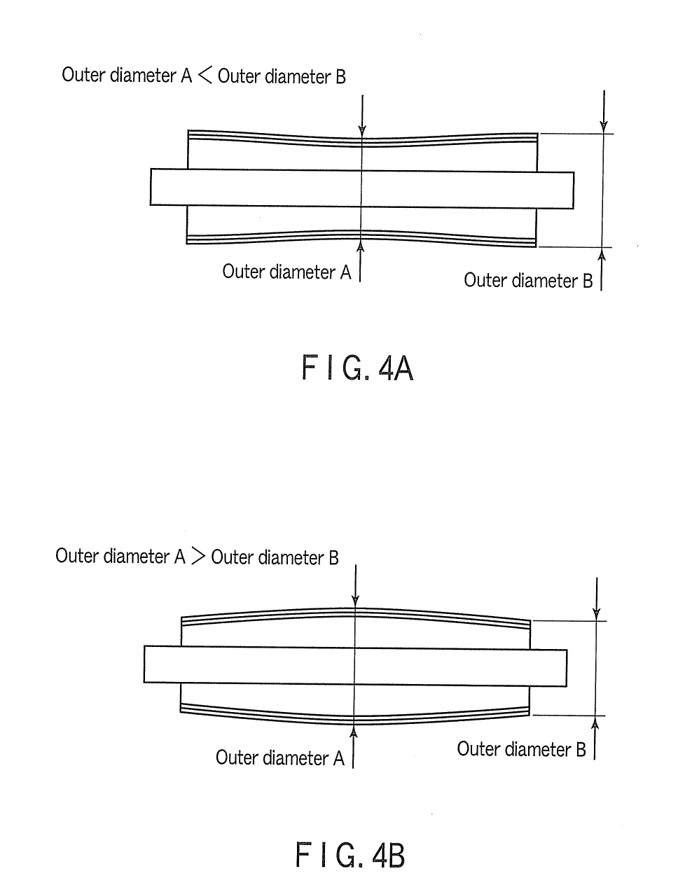

One of the first roller 91 and the second roller 92 is rotated in an arrow direction by thrust transmitted by a motor, a gear train, or a belt. The other roller is rotated (driven) according to the rotation of the one roller that comes into contact with the other roller via the nip. When at least one of the first roller 91 and the second roller 92 includes a belt member, a direction in which a belt surface of the belt member moves is the same as the direction of rotation of a rotating shaft that moves the belt surface in the arrow direction (FIG. 2). The first roller 91 and the second roller 92 have a relation in which, in (longitudinal direction) sections including rotation centers (center axes) and cut in parallel to the rotation centers (the center axes), a diameter A generally in the center in the longitudinal direction and a diameter B at ends of one roller are opposite to those of the other roller (see FIGS. 4A and 4B). In one roller, the diameter A is smaller than the diameter B and, in the other roller, the diameter A is larger than the diameter B. The roller having the diameter A larger than the diameter B is referred to as, for example, a barrel (drum) type roller. By combining both the rollers, wrinkles can be prevented from being formed on the sheet member carrying the toner.

One of the first roller 91 and the second roller 92 used as a pressing roller desirably has higher hardness (harder) than a heating roller. The roller used as the pressing roller is desirably made of, for example, aluminum or iron.

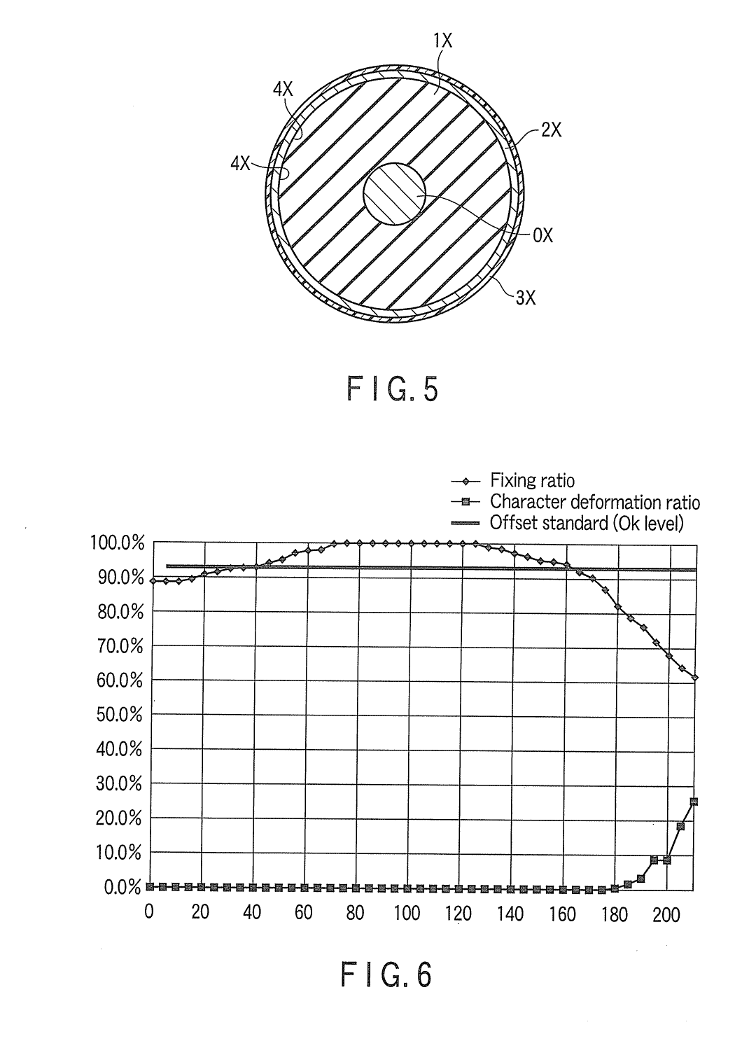

As indicated by an example shown in FIG. 5, one of the first roller 91 and the second roller 92 functioning as the heating roller desirably includes an elastic body, for example, gel-like silicone (hereinafter referred to as silicone gel layer) 1×. The silicone gel layer 1X as a roller structure includes a shaft (a cored bar) 0X in a center axis (a rotation center). The shaft 0X is desirably made of metal that withstands temperature (heat) of 250° C. The shaft 0X is not deformed by the contact with the pressing roller (pressure from the pressing roller) or, when the shaft 0X is a rotating shaft that moves the belt surface of the belt member, by tension generated by the entire belt member. Therefore, the shaft 0X has thickness, a material, a shape (as the shaft alone, a shaft non-columnar in section can be used), and the like managed in various management values. When the belt member is used instead of the heating roller, a cylinder without the shaft 0X can also be used.

The silicone gel layer 1X has a conductive layer 2X on the outer circumference. The conductive layer 2X has a release layer (a PFA layer) 3X on the outer circumference. A rubber layer 4X may be provided between the conductive layer 2X and the release layer 3X. An adhesive material (layer) may be included between the conductive layer 2X and the release layer 3X (when the rubber layer 4X is provided, between the conductive layer 2X and the rubber layer 4X and between the rubber layer 4X and the release layer 3X).

The thickness of the conductive layer 2X is 50-500 μm, preferably, and the thickness of the release layer 3X is 30-50 μm, preferably. When the layers are formed as a roller, a modulus of elasticity of a surface defined by the silicone gel layer 1X, the conductive layer 2X, and the release layer 3X (the outer circumferential surface of a roller member) is extremely high (the outer circumferential surface is soft) compared with, for example, a roller including an aluminum cylinder. As the conductive layer 2X, a cylinder may be prepared in advance. The conductive layer 2X may be formed on the outer circumference of the silicone gel layer 1X by an arbitrary method such as deposition, plating, or electro-casting.

When the roller member including the silicone gel layer 1X is used as the pressing roller, the conductive layer 2X is not always necessary. Since the silicone material has low thermal conductivity compared with iron and aluminum, when the roller member is used as, for example, the pressing roller, a degree of a fall in the temperature on the heating roller side (escape of heat from the heating roller in heating) is lower than that in the case of a metal roller. Therefore, heating time required for warming-up can be reduced.

The silicone material used for the silicone gel layer 1X withstands heat (temperature) of 250° C. (heat resistant temperature is 250° C.). The silicone material is an elastic member excellent in repeated stress and having high return performance. Hardness of the silicone material indicates 45 to 160 in the penetration test JIS K2207. Silicone displays fluidity in a degree of liquid having high viscosity in the room temperature and indicates hardness of about 5 to 200 in the penetration test JIS K2207 at predetermined curing temperature. The silicone material is cured by microwave heating. The microwave heating can be performed from both the outer circumference side and the inner circumference side (inner side) (when the silicon material is heated from the inner circumference side (the inner side), a tube or a resin pipe needs to be prepared for curing). The silicone material has thermal conductivity of 0.1 to 0.2 (W/m·K). For the measurement, a quick thermal conductivity meter QTM500 manufactured by Kyoto Electronics Manufacturing Co., Ltd. was used.

TABLE 1

| | | Character |
|---|---|---|
| Penetration | Fixing ratio | deformation ratio |
| 5 | 88.6% | 0.0% |
| 10 | 88.9% | 0.0% |
| 15 | 89.3% | 0.0% |
| 20 | 90.7% | 0.0% |
| 25 | 91.6% | 0.0% |
| 30 | 92.4% | 0.0% |
| 35 | 92.7% | 0.2% |
| 40 | 93.4% | 0.0% |
| 45 | 94.0% | 0.0% |
| 50 | 95.2% | 0.0% |
| 55 | 96.7% | 0.0% |
| 60 | 97.6% | 0.0% |
| 65 | 98.1% | 0.0% |
| 70 | 100.0% | 0.0% |
| 75 | 100.0% | 0.0% |
| 80 | 100.0% | 0.0% |
| 85 | 100.0% | 0.0% |
| 90 | 100.0% | 0.0% |
| 95 | 100.0% | 0.0% |
| 100 | 100.0% | 0.0% |
| 105 | 100.0% | 0.0% |
| 110 | 100.0% | 0.0% |
| 115 | 100.0% | 0.0% |
| 120 | 100.0% | 0.0% |
| 125 | 99.6% | 0.0% |
| 130 | 99.2% | 0.0% |
| 135 | 98.5% | 0.0% |
| 140 | 97.4% | 0.0% |
| 145 | 96.3% | 0.0% |
| 150 | 95.1% | 0.0% |
| 155 | 94.8% | 0.0% |
| 160 | 94.2% | 0.0% |
| 165 | 92.1% | 0.0% |
| 170 | 90.4% | 0.0% |
| 175 | 87.2% | 0.2% |
| 180 | 82.4% | 0.7% |
| 185 | 79.2% | 1.8% |
| 190 | 76.3% | 3.6% |
| 195 | 72.1% | 8.9% |
| 200 | 68.4% | 9.0% |
| 205 | 64.7% | 18.6% |
| 210 | 62.0% | 26.0% |

Table 1 and FIG. 6 show a result of evaluation of image outputs obtained as a result of changing the hardness of gel in the fuser unit in which a roller with elasticity improved by using silicone gel is applied to a heating roller. FIG. 6 is a graph corresponding to Table 1.

The hardness (a test value) of the gel is indicated by the penetration test JIS K2207.

The fixing ratio used for determination indicates an occurrence percentage (100—occurrence frequency (%)) of “high temperature offset” or “low temperature offset” during image formation (image output) on 60 thousand (60×10³) sheets, which is a standard value for maintenance.

The character deformation occurrence ratio used for the determination indicates an occurrence ratio (100—occurrence frequency (%)) of “image outputs of complicated characters not satisfying a predetermined standard” during image formation (image output) on 60 thousand (60×10³) sheets, which is a standard value for maintenance. The predetermined standard is, for example, “a part of a portion that should be blank is deformed”. Absolute evaluation by numerical values can be performed by using an MTF (Modulation Transfer Function) of “Chinese character” in which lateral lines are present at an arbitrary pitch and “size (number of points)” of the “Chinese character” or a line pair separation test image.

As it is evident from Table 1, when the penetration test (value) JIS K2207 is 160, deformation of a character in an image output occurs. As a cause of the character deformation, extended pressing time for a sheet (a sheet member) is conceivable.

When the penetration test (value) is 170, the character deformation occurrence ratio is as high as 17.2%. As a cause of the character deformation, excessively high hardness of a roller is conceivable. When a color image is output, gloss cannot be sufficiently obtained. As a cause of the insufficient gloss, for example, since plural toner layers (multiple layers) form the color image, characteristics of gloss components, which should be obtained by melting of toners of respective colors, cannot be sufficiently brought out.

When the penetration test (value) is smaller than 45, restoration properties after pressing (force for returning to an original shape when application of pressure is released) are insufficient. It is not allowed to, for example, use a ship during transportation (500 hours or more is necessary as the elapse of time in a pressed state).

When the penetration test (value) is 45 to 160, the fixing ratio is equal to or higher than 94% and the character deformation occurrence ratio is 0%. When the penetration test (value) is in a range of 70 to 120, the fixing ratio is improved to 100%.

The evaluation explained above can also be easily confirmed with reference to FIG. 6.

The roller structure shown in FIGS. 2 to 5 can also be used for, for example, a paper feeding (friction) roller included in a paper feeding unit 11.

In one of the first roller 91 and the second roller 92 functioning as the heating roller, the silicone gel layer 1X includes a metal filler or a magnetic filler. As the metal filler or the magnetic filler, nickel (Ni), iron (Fe), stainless steel (indicating multiple characteristics according to contents of Ni—Cr), silver (Ag), or aluminum (Al) can be used. An arbitrary material is used to obtain requested thermal conductivity. The arbitrary material is desirably nickel (Ni).

When the silicone gel layer 1X includes the metal filler or the magnetic filler, in particular, the magnetic filler, if a heating device is an IH, the depth of penetration of a magnetic flux to the inner side of the conductive layer 2X increases. Therefore, a temperature rise (heat generation efficiency) of the conductive layer 2X is improved.

Specifically, when the roller member including the silicone gel layer 1X including the metal filler or the magnetic filler is used as the heating roller, the roller member assists an amount of generation of heat (temperature rise) generated by the conductive layer 2X (in particular, during IH heating). Therefore, a heating time in raising the surface temperature of the roller to fixing (fixable) temperature can be, reduced. Energy (electric power) necessary for heating can be suppressed. This makes it possible to reduce warming-up time.

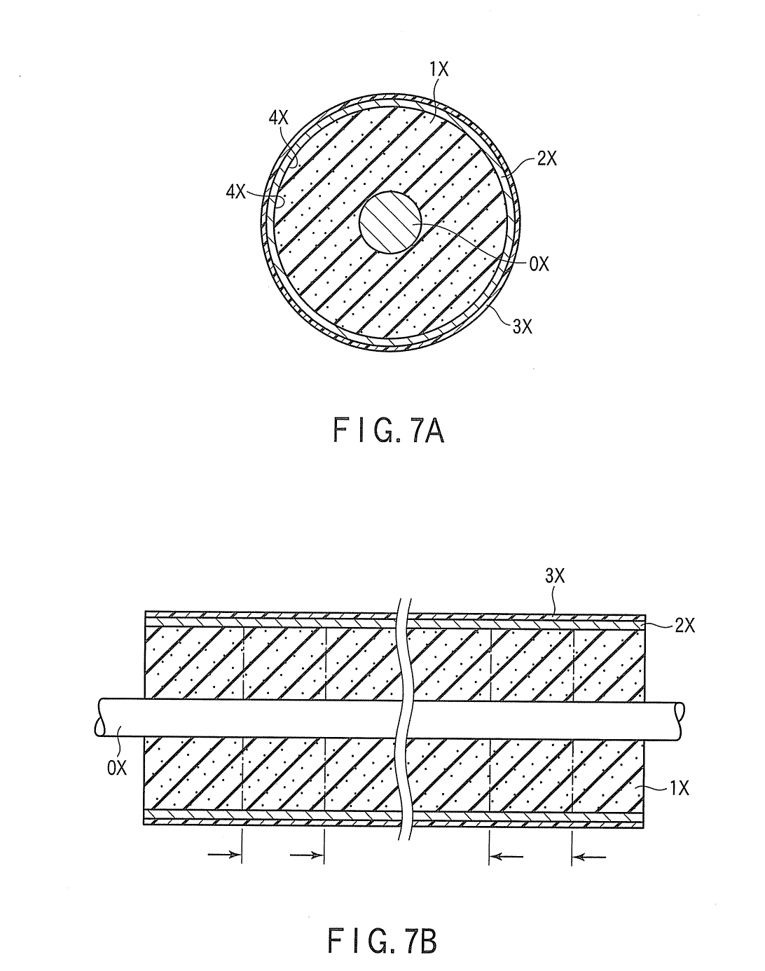

When the silicone gel layer 1X includes the metal filler or the magnetic filler, desirably, as indicated by an example shown in FIG. 7A, the concentration (the content) of the metal filler or the magnetic filler is changed in a radial direction and is increased near the conductive layer 2X. For example, a concentration difference can be defined by a centrifuge separation method. The concentration and the material can also be partially changed by forming, stepwise, two or more thin layers of the metal filler or the magnetic filler having different concentrations or contained materials. Electrophoresis can also be applied by suitably controlling a type of a material contained in the metal filler or the magnetic filler and hardness before curing (viscosity) of the gel.

As indicated by an example shown in FIG. 7B, it is desirable to change the concentration (the content) of the metal filler or the magnetic filler in the longitudinal direction and increase the concentration (the content) of the metal filler or the magnetic filler near the center. For example, this can be easily attained by, when the conductive layer 2X is prepared in a cylindrical shape and the gel is injected into the conductive layer 2X, changing the concentration (the content) of the metal filler or the magnetic filler included in each of the gel located at both the ends and the gel located near the center. When workability is taken into account, plural kinds, for example, about three kinds of gel having different concentrations (contents) of the metal filler or the magnetic filler are prepared and the gel injected into a region near one end, a region between the one end and the center, a region near the center, a region between the center and the other end, and a region near the other end (about five places in total) is changed. This makes it possible to obtain a concentration gradient of the metal filler or the magnetic filler. During the injection, a material of the metal filler or the magnetic filler contained in the gel can also be arbitrarily changed.

The region between one end and the center and the region between the center and the other end are defined on the basis of, for example, a sheet member used for image output. For example, in image formation in which the sheet member is conveyed in parallel to a long side of the sheet member, a temperature rise at both the ends or at one end in the longitudinal direction of the heating roller is unnecessary in conveyance of the sheet member during, for example, reduction copying from 11×17 inches (A3 size) to 8·½×11 inches (A4 size). Therefore, a concentration gradient of the metal filler or the magnetic filler or a boundary portion of the material of the metal filler or the magnetic filler can be set.

The metal filler or the magnetic filler is used a material and/or a material combination with at least one of the material shown in Table 2.

TABLE 2

| | Before milling (μm) | | After milling (μm) | | | | |
|---|---|---|---|---|---|---|---|
| | Raw | Raw | | | | Processed | Milling |
| | materials | materials | Products | Products | Model | amount | pressure |
| Name of Article | × 50 | ×100 | × 50 | × 100 | name | (g/Hr) | (Mpa) |
| molybdenum | 8.05 | 45 | 0.62 | 2 | NJ-30 | 104 | 0.5 |
| disilicide | | | | | | | |
| silver powder | 1.04 | 4 | 0.47 | 1.6 | NJ-100 | 4,000 | 0.58 |
| cobalt-based | 15.1 | 56 | 1.45 | 6 | NJ-100 | 1,900 | 1.5 |
| alloy | | | | | | | |
| coarse-magnesium | 85.89 | 300 | 75.03 | 240 | NJ-30 | 60 | 0.3 |
| cuprous oxide | 9.96 | 36 | 0.32 | 0.7 | NJ-50 | 150 | 0.9 |
| alumina | 1.42 | 6 | 0.87 | 3 | NJ-100 | 2,000 | 0.5 |
| alumina | 28.99 | 140 | 0.87 | 8 | NJ-30 | 180 | 0.3 |
| alumina | 1.66 | 8 | 0.33 | 2 | NJ-50 | 180 | 0.65 |
| alumina powder | 0.44 | 2 | 0.3 | 1.4 | NJ-50 | 635 | 0.05 |
| iridium | 7.64 | 30 | 2.58 | 18 | NJ-50 | 60 | 0.45 |
| metallic oxide | 3.43 | 30 | 1 | 4 | NJ-100 | 3,500 | 0.95 |
| metallic oxide | 39.7 | 112 | 11.62 | 30 | NJ-30 | 60 | 0.5 |
| metal powder | 68.66 | 180 | 16.73 | 56 | NJ-100 | 900 | 1.4 |
| lead chromate | 1.52 | 15 | 0.65 | 4 | NJ-100 | 7,500 | 0.35 |
| barium chromate | 260.9 | 500 | 2.92 | 18 | NJ-100 | 5,000 | 0.35 |
| zinc oxide | 13.65 | 55.95 | 0.33 | 4 | NJ-50 | 212 | 0.3 |
| zinc oxide | 57.23 | 500 | 0.89 | 4 | NJ-50 | 420 | 0.7 |
| zinc oxide | 0.79 | 6 | 0.19 | 3 | NJ-50 | 120 | 0.15 |
| titanium oxide | 84.36 | 240 | 1.12 | 3 | NJ-30 | 270 | 0.4 |
| titanium oxide | 18.28 | 112 | 1.39 | 12 | NJ-50 | 100 | 0.85 |
| titanium oxide | 48.44 | 400 | 1.04 | 3.58 | NJ-50 | 100 | 0.85 |
| iron oxide | 4.79 | 30 | 0.08 | 0.4 | NJ-50 | 120 | 1.4 |
| lead oxide | 3.51 | 15 | 0.98 | 4 | NJ-50 | 3 | 0.4 |
| nickel oxide | 1.95 | 8 | 0.44 | 4 | NJ-100 | 2,400 | 0.4 |
| nickel oxide | 1.66 | 8 | 1.11 | 4 | NJ-30 | 240 | 0.6 |
| nickel oxide | 11.36 | 36 | 1.15 | 8 | NJ-50 | 180 | 0.5 |
| nickel oxide | 0.35 | 4 | 0.31 | 1.4 | NJ-50 | 480 | 0.25 |
| Magnesium oxide | 2.01 | 30 | 1.3 | 6 | NJ-100 | 9 | 1.4 |
| Manganese oxide | 18.59 | 56 | 0.15 | 0.7 | NJ-50 | 120 | 0.15 |
| iridium trioxide | 0.79 | 6 | 0.58 | 2 | NJ-50 | 60 | 0.45 |
| bismuth trioxide | 2.67 | 8 | 0.57 | 2 | NJ-50 | 550 | 0.45 |
| barium nitrate | 260.9 | 500 | 2.92 | 18 | NJ-100 | 5,000 | 0.35 |
| Tin | 10.18 | 23 | 0.21 | 1 | NJ-100 | 1,527 | 1.5 |
| iron powder | | several | 4.1 | 10 | NJ-50 | 120 | 0.8 |
| | | millimeter | | | | | |
| copper | 36.78 | 112 | 8.18 | 36 | NJ-100 | 1,000 | 1.5 |
| copper | 47.98 | 120 | 0.82 | 6 | NJ-100 | 3,500 | 1.5 |
| Lead | 0.55 | 23 | 0.22 | 1 | NJ-50 | 114 | 0.3 |
| lead dioxide | 3.51 | 15 | 0.98 | 4 | NJ-100 | 3,000 | 0.4 |
| Composite oxide | 29.54 | 112 | 0.41 | 1.3 | NJ-100 | 1,500 | 1.4 |
| platinum | 4.83 | 18 | 0.12 | 0.4 | NJ-30 | 300 | 0.2 |
| chromium boride | 40.52 | 112 | 0.56 | 2 | NJ-30 | 60 | 0.45 |
| chromium boride | 40.52 | 112 | 0.56 | 2 | NJ-30 | 60 | 0.45 |

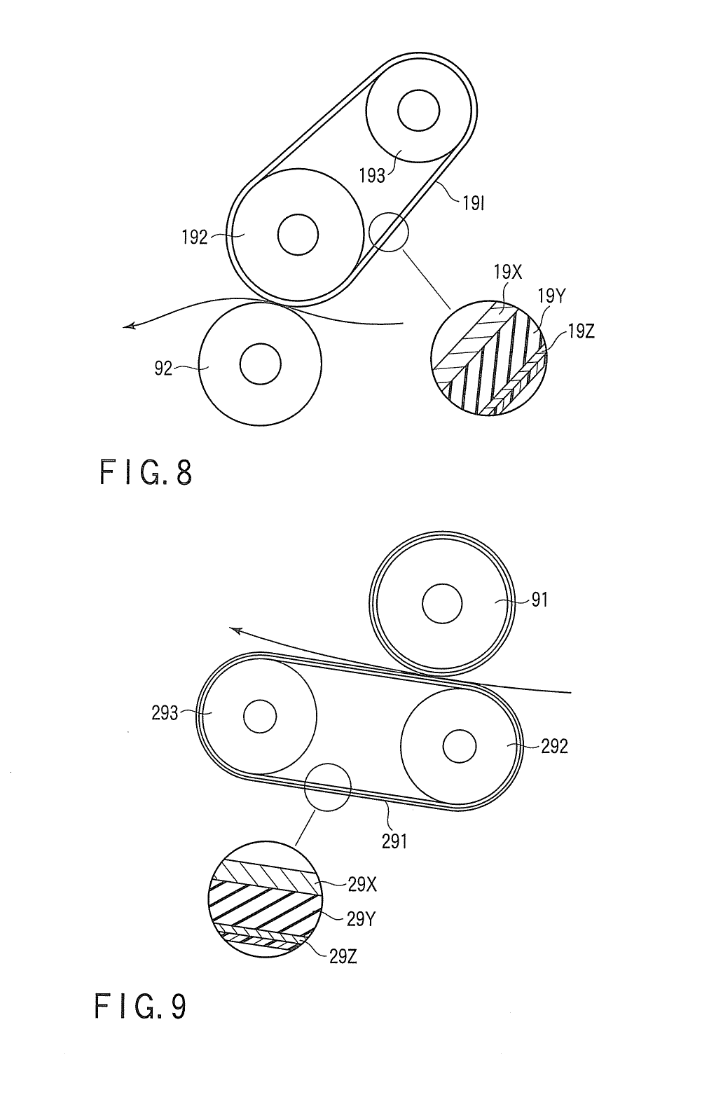

In the fuser unit, as shown in FIG. 8, at least one of the first roller and the second roller may be formed in a belt shape as long as a nip having predetermined width can be provided.

In an example shown in FIG. 8, a belt 191 includes at least a base film 19X, a silicon gel layer 19Y, and a conductive layer 19Z. The belt 191 is an example of a replacement of the heating roller. The belt 191 is applied with predetermined tension by a tension roller 192 and a driving roller 193 that rotates with torque received from the outside.

In the fuser unit, as shown in FIG. 9, at least one of the first roller and the second roller may be formed in a belt shape as long as a nip having predetermined width can be provided.

In an example shown in FIG. 9, a belt 291 includes at least a base film 29X, a silicone gel layer 29Y, and a surface rubber layer 29Z. The belt 291 is an example of a replacement of the pressing roller. The belt 291 is applied with predetermined tension by an auxiliary roller 292 and a driving roller 293 that rotates with torque received from the outside.

As explained above, with the fuser unit according to the embodiment, a fixing ratio in fixing a recording material (a toner) to a sheet member (a sheet) is improved. In the fixing, a character or a line pair represented by the recording material can be prevented from being deformed (being unable to be reproduced as an image). A change in a degree of gloss caused by the recording material is reduced. Time necessary for a temperature rise (heating) to the fixable temperature can be reduced. Energy (electric power) necessary for a temperature rise (heating) to the fixable temperature can be reduced.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A fuser comprising:
a first endless member including a gel-like silicone material and configured to apply heat to an object;
a second endless member configured to apply pressure to the first endless member; and
a heat source configured to raise temperature of the first endless member to predetermined temperature.

2. The fuser of claim 1, wherein the gel-like silicone material of the first endless member has, as hardness after curing, penetration of 45 to 160 in a penetration test JIS K2207.

3. The fuser of claim 2, wherein the penetration is desirably 70 to 120.

4. The fuser of claim 2, wherein the gel-like silicone material of the first endless member includes a metal filler or a magnetic filler.

5. The fuser of claim 4, wherein the gel-like silicone material of the first endless member includes a metal filler containing Ni.

6. The fuser of claim 4, wherein the metal filler or the magnetic filler of the gel-like silicone material has partially different concentration of a filler material.

7. The fuser of claim 1, wherein the first endless member is in contact with a recording material carried on the object.

8. The fuser of claim 7, wherein the gel-like silicon material of the first endless member has, as hardness after curing, penetration of 45 to 160 in a penetration test JIS K2207.

9. The fuser of claim 8, wherein the penetration is desirably 70 to 120.

10. The fuser of claim 8, wherein the gel-like silicone material of the first endless member includes a metal filler or a magnetic filler.

11. The fuser of claim 10, wherein the gel-like silicone material of the first endless member includes a metal filler containing Ni.

12. The fuser of claim 10, wherein the metal filler or the magnetic filler of the gel-like silicone material has partially different concentration of a filler material.

13. The fuser of claim 1, wherein the heat source is an IH type.

14. The fuser of claim 13, wherein the gel-like silicon material of the first endless member has, as hardness after curing, penetration of 45 to 160 in a penetration test JIS K2207.

15. The fuser of claim 14, wherein the penetration is desirably 70 to 120.

16. An image forming apparatus comprising:
a developing unit configured to visualize image information with a visualizing agent;
a transfer unit configured to transfer the visualizing agent, which visualizes the image information, onto a sheet; and
a fuser including:
a first endless member including a gel-like silicone material and configured to apply heat to an object;
a second endless member configured to apply pressure to the first endless member; and
a heat source configured to raise temperature of the first endless member to predetermined temperature.

17. The apparatus of claim 16, wherein the heat source of the fuser is an IH type.

18. The apparatus of claim 17, wherein the gel-like silicone material of the first endless member of the fuser has, as hardness after curing, penetration of 45 to 160 in a penetration test JIS K2207.

19. The apparatus of claim 17, wherein the gel-like silicone material of the first endless member of the fuser includes a metal filler or a magnetic filler.

20. The apparatus of claim 19, wherein the metal filler or the magnetic filler of the gel-like silicone material has partially different concentration of a filler material.
